(19) United States
(12) Patent Application Publication
(10) Pub. No.: US 2023/0336852 A1
(43) Pub. Date: Oct. 19, 2023

(54) Trail Camera Shroud Assembly

(71) Applicants: Jason M. Bond, Belle Plaine, KS (US); Demetra D. Bond, Belle Plaine, KS (US)

(72) Inventors: Jason M. Bond, Belle Plaine, KS (US); Demetra D. Bond, Belle Plaine, KS (US)

(73) Assignees: Jason M. Bond, Belle Plaine, KS (US); Demetra D. Bond, Belle Plaine, KS (US)

(21) Appl. No.: 18/212,307

(22) Filed: Jun. 21, 2023

(51) Int. Cl. H04N 23/51

(52) U.S. Cl. CPC H04N 23/51

(57) ABSTRACT

An assembly for shrouding a motion actuated trail camera of the type incorporating a shell, first lateral and oppositely lateral walls having forward ends, a first rear wall, a first upper wall having a forward end, and an antenna, the assembly incorporating a second upper wall, a second lateral wall extending downwardly from the second upper wall's lateral end, a second oppositely lateral wall extending downwardly from the second upper wall's oppositely lateral end, a second rear wall extending downwardly from the second upper wall's rear end, and second and third apertures respectively opening at the second rear wall and the second lateral wall, the second aperture being positioned for, upon an installation of the antenna within and through the third aperture, rearwardly overlying the first aperture.

### FIELD OF THE INVENTION

This invention relates to digital video trail cameras of the type which are commonly motion actuated, such cameras being used to obtain video or still images of wildlife. More particularly this invention relates to apparatus and assemblies which are adapted for protecting such trail camera equipment from adverse weather and environmental conditions.

### BACKGROUND OF THE INVENTION

Motion actuated trail cameras commonly comprise a shell or case which internally houses digital video electronics, a miniature video camera, a battery power supply and cellular connection electronics. Such camera cases commonly have a front wall or forward camera port which is exposed to rain and snow. Upon mounting of such cameras upon a tree or post, snow and moisture often accumulates upon the case's upper surface, undesirably degrading the case and threatening incursions of moisture into the case. Snow and rain falling upon upper surfaces of a trail camera may undesirably obscure the camera's forward lens or lens cover, interfering with the quality of images collected by the camera. Also, unprotected upper surfaces of such camera cases may be undesirably used by birds and squirrels as a perching ledge, resulting in degradation of the case through animal contacts.

The instant inventive trail camera shroud solves or ameliorates problems and challenges described above by providing a mechanically simple and economically produced covering member which may be easily, securely, and removably attached to commonly configured camera cases. Such functional advantages are achieved by provision of specialized rear and sidewall components which engage commonly present camera case rear and side wall structural features.

### BRIEF SUMMARY OF THE INVENTION

The instant inventive assembly is intended for use in shrouding and protecting a trail camera, typically of the type which is motion sensor actuated. Such trial cameras commonly incorporate an onboard rechargeable battery which continuously powers a low amperage and low voltage passive infrared sensor. Such sensor actuates and deactuates a miniature video camera housed within the camera's case or shell, the camera also being powered by the onboard rechargeable batteries. Such trail cameras commonly house cellular data output electronics for uploading recorded animal video recordings and images to internet cloud storage. Such cellular data adapted trail cameras commonly include a sidewall mounted cellular signal transmitting antenna.

The case or shell of a trail camera shrouded by the instant inventive assembly commonly comprises a first upper wall, a first lateral wall, a first oppositely lateral wall, and a first rear wall. Such case or shell also commonly comprises a first aperture which is configured as a rearwardly opening helically threaded mounting socket embedded within the case's first rear wall.

The instant inventive assembly, in coordination with such first structures common to trail cameras, comprises a second upper wall having front and rear ends, and having lateral and oppositely lateral ends. In a preferred embodiment, the assembly's second upper wall component is composed of plastic, has a lateral dimension slightly greater than the lateral dimension of the case's first upper wall, and has a longitudinal or front to rear dimension markedly greater than the front to rear dimension of the case's first upper wall. Such excess dimensions advantageously form a weather protective eve at the front of the shroud.

Further structural components of the instant inventive assembly comprise a second lateral wall and a second oppositely lateral wall. In the preferred embodiment, such walls are fixedly attached to and respectively extend downwardly from the lateral and oppositely lateral ends of the case's second upper wall. Such fixed attachments comprise wholly formed bends or joints within the preferably plastic matrixes of the interconnected walls. In addition to their downward extensions the second lateral and second oppositely lateral walls preferably splay respectively laterally and oppositely laterally, providing slope angles which advantageously direct drainage of falling rain or snow away from the camera case.

A further structural component of the instant inventive assembly comprises a second rear wall which is fixedly attached to and extends downwardly from the rearward end of the second upper wall. In the preferred embodiment, such second rear wall is composed of plastic, is wholly formed with the second upper wall, and is configured as a relatively narrow downwardly extending support leg.

Where, as is common, the case or shell of a trail camera to be shrouded by the instant inventive assembly presents a first aperture or socket which opens rearwardly at the case's first rear wall, the instant inventive assembly preferably further comprises an alignable second aperture which opens at a distal or downward end of the second rear wall. Such cases' first apertures are commonly internally helically threaded, presenting shroud threads within a metal sleeve which line the first apertures. Where the case's first aperture includes such screw threads, the instant inventive assembly preferably further comprises a screw which is sized for forward extension through the second aperture and into threaded engagement with the first aperture.

Where, as is common, a trail camera to be shrouded by the instant inventive assembly presents a side wall mounted cellular antenna, the assembly preferably further comprises a third aperture which is fitted for receipt of a typically “L” shaped mounting base or foot of such antenna. In the preferred embodiment, the mounting screw receiving second aperture is positioned upon the second rear wall so that, upon a receipt of the antenna base within and through the lateral wall's third aperture, the second rear wall's second aperture aligns with the first rear wall's first aperture.

In use of the instant inventive assembly, an operator may initially unscrew and remove the trail camera's cellular antenna. Thereafter, the shroud may be placed directly over the trail camera's first upper wall. Upon such shroud placement, the shroud's second lateral wall and second oppositely lateral wall respectively laterally and oppositely laterally overlie the camera shell's first lateral wall and first oppositely lateral wall. Upon achieving such overlying placements of the assembly's shroud components, the second and third apertures respectively align with the first aperture and the camera's antenna mounting socket. Thereafter, the base of the cellular antenna may be extended oppositely laterally through the third aperture for screw threaded engagement with and mounting upon the camera shell.

As indicated above, upon the alignment and mounting of the cellular antenna within and through the assembly's third aperture, the first and second apertures at the rear of the camera shell advantageously align. Thereafter, the assembly's preferably provided mounting screw component may be extended forwardly therethrough for threaded engagement with the camera shell's threaded first aperture.

Close fitting of the assembly's antenna receiving third aperture with the circular cross-sectional shape of the base of the cellular antenna advantageously supports and stabilizes the camera shroud by resisting rotation of the camera shroud about its rear screw fastened mount. Accordingly, the screw within the assembly's second aperture in combination with the extension of the antenna base through the third aperture achieve a firm and secure attachment of the shroud upon the camera.

In a suitable embodiment, shroud mounting stability is alternatively achieved by provision of a first, and preferably first and second “T” ridge and “T” channel joints which directly attach the shroud's second upper wall to the camera shell's first upper wall.

Accordingly, objects of the instant invention include the provision of an assembly for shrouding a motion actuated trail camera which incorporates structures, as described above, and which arranges those structures in relation to each other in manners described above, for the performance of beneficial functions, as described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive assembly for shrouding a motion actuated trail camera.

FIG. 2 is a rear view of the structures of FIG. 1.

FIG. 3 is a perspective view of the trail camera of FIG. 1, the view of FIG. 3 showing shroud assembly components removed.

FIG. 4 is a rear view of the structure of FIG. 3.

FIG. 5 is presents an alternate embodiment of the structure of FIG. 3.

FIG. 6 is a rear view of the structure of FIG. 5.

FIG. 7 is an alternate embodiment of the structures of FIG. 2.

FIG. 8 is an alternate perspective view of the assembly of FIG. 1, the trail camera of FIG. 1 being removed.

### DETAILED DESCRIPTION OF THE INVENTION

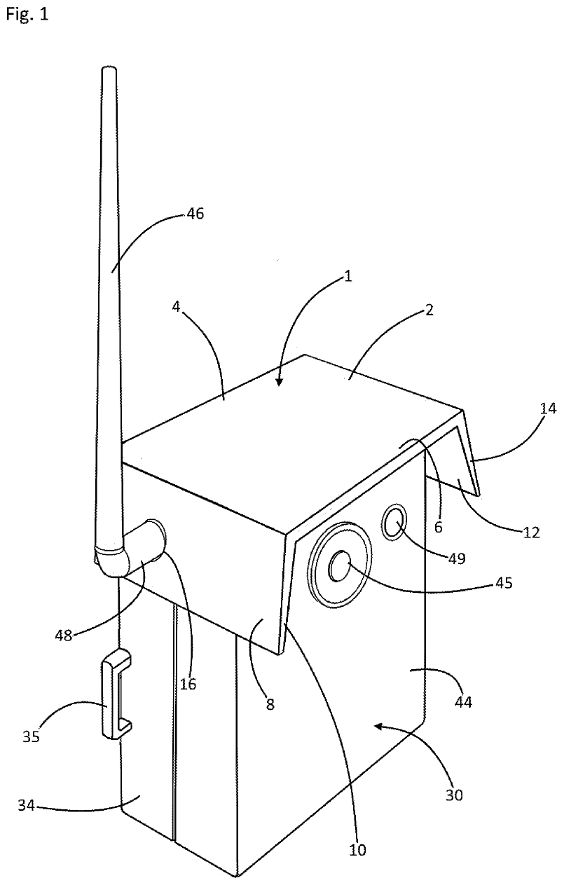

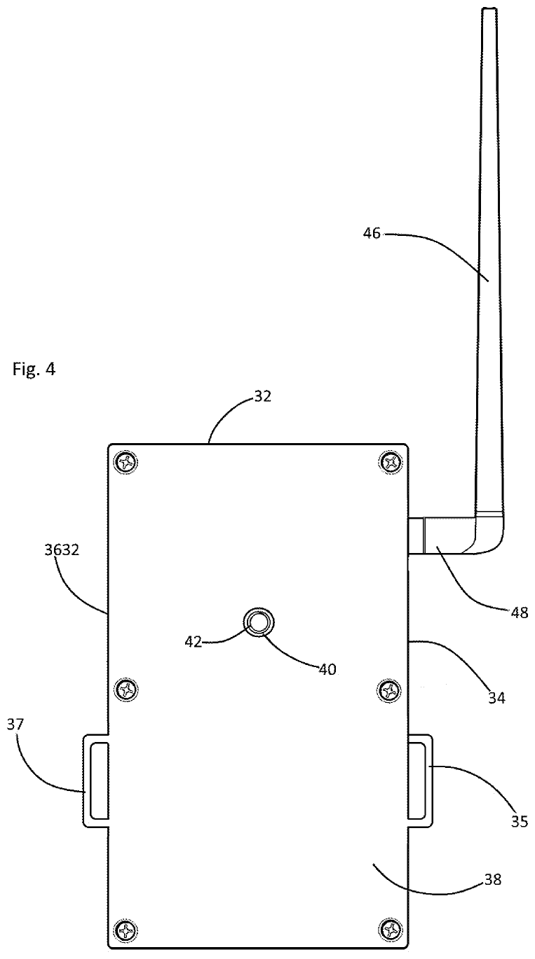

Referring now to the drawings, and in particular, simultaneously to FIGS. 1-4, a commonly configured motion actuated trail camera upon which the instant inventive assembly may be installed is referred to generally by reference arrow 30. Such trail camera 30 has a case or shell which comprises a first upper wall 32, a first lateral wall 34, a first oppositely lateral wall 36, and a first rear wall 38. Such shell houses an electronic miniature video camera whose forward lens 45 is presented at the case's front wall 44. Such trail camera 30 is commonly motion actuated by mean of an electronic on board passive infrared motion sensor 49. Such camera 30 is also commonly adapted for cellular transmission of video images and recordings, the camera including a sidewall mounted cellular antenna 36 having a screw mountable “L” base or foot 48. Such antenna base 48 may be conveniently removably mounted upon the case's first lateral wall 34 by means of a socket mount 47 which presents female screw threads (not depicted within views).

The trail camera 30 commonly further comprises a first aperture 40 which is embedded within and opens rearwardly at the case's first rear wall 38. Such first aperture 40 commonly has internal helical threads 42, and is conventionally utilized to facilitate wall or post mounts of the camera 30. Such camera 30 also commonly includes strap receiving loops 35 and 37 for mounting of the camera upon structures such as a tree or post.

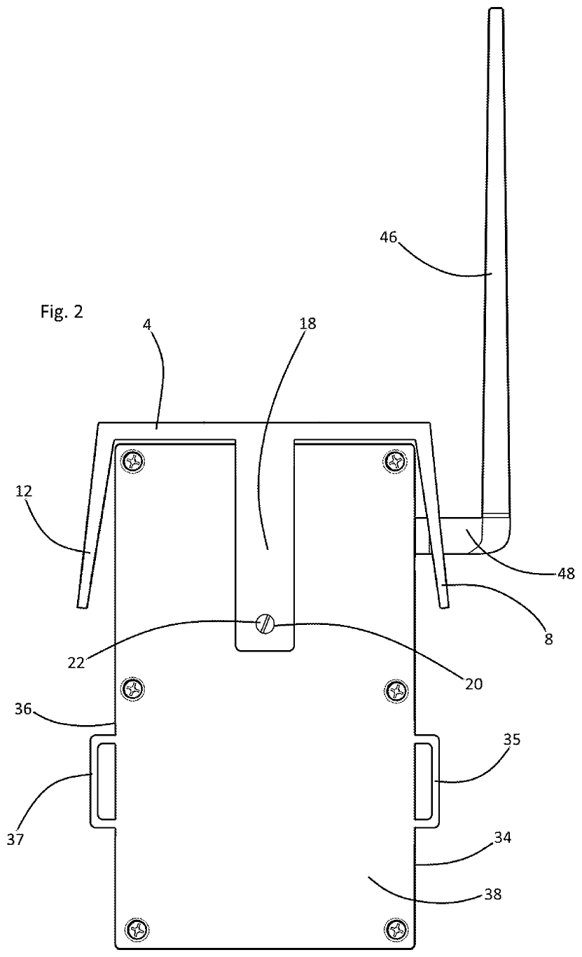

Referring in particular to FIGS. 1 and 2, a preferred embodiment of the instant inventive shroud assembly is referred to generally by reference arrow 1, such assembly comprising a second upper wall 2 having a rearward end 4 and a forward end 6. The shroud's second upper wall 2 is preferably composed of durable plastic.

A further structural component of the instant inventive assembly comprises a second lateral wall 8 having a forward end 10. Such wall 8 is fixedly attached to and extends downwardly from the lateral end of the second upper wall 2, and in the preferred embodiment, such attachment comprises a whole formation of the plastic matrixes of the second lateral wall 8 and the second upper wall 2.

A further structural component of the instant inventive assembly comprises a second oppositely lateral wall 12 having a forward end 14, such second oppositely lateral wall preferably being mirroringly configured with respect to the second lateral wall 8.

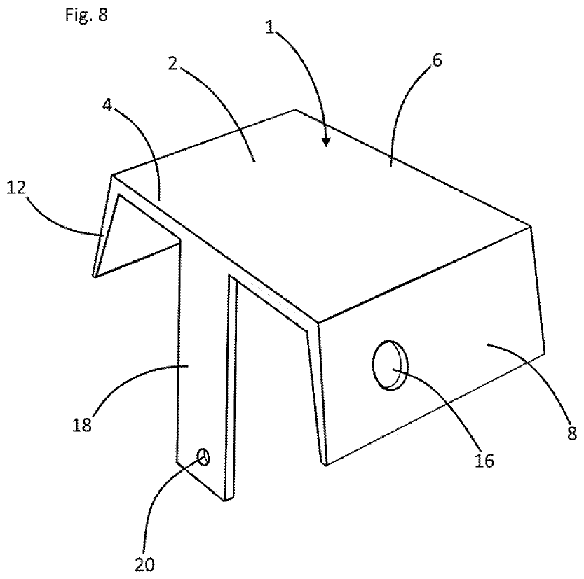

Referring further simultaneously to FIG. 8, a further structural component of the instant inventive assembly comprises a second rear wall 18, which is fixedly attached to and extends downwardly from the rearward end 4 of the second upper wall 2. The second rear wall 18 is suitably configured, as depicted, as a downwardly extending and relatively narrow support leg. Such second rear wall component 18 presents at its lower or distal end a second aperture 20, which is adapted for receipt of a mounting screw 22.

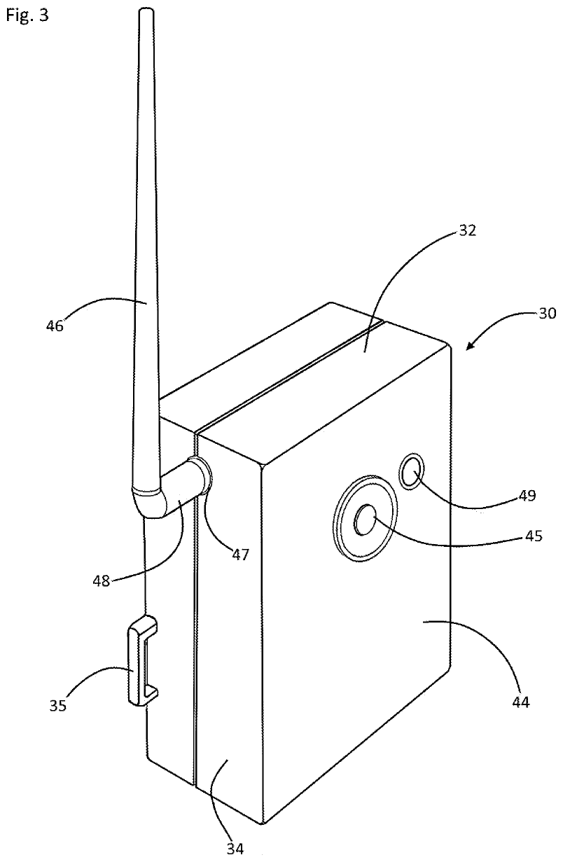

Referring in particular to FIG. 1, the instant inventive assembly preferably further comprises a third aperture 16 which opens at the second lateral wall 8. Such third aperture 16 is preferably closely fitted to allow a nesting oppositely lateral extension of the base 48 of the cellular antenna 46 therethrough. Upon such extension, referring in particular to FIG. 3, the base 48 of such antenna may be screwed into antenna socket 47.

Referring simultaneously to FIGS. 1-4, the assembly's second aperture 20 and third aperture 16 are preferably relatively positioned so that, upon a screw mounting extension of the antenna base 48 into threaded engagement with antenna socket 47, the second aperture 20 substantially aligns with the case's first aperture 40. Such alignment advantageously allows a forward extension and screw installation of mounting screw 22.

In the assembly of FIGS. 1-4, the rear wall 18, the second aperture 20 and first aperture 40 securely position the shroud 1 so that the second upper wall 2 overlies the camera 30, and so that the case's second lateral and oppositely lateral walls 8 and 12 respectfully laterally and oppositely laterally overlie the case's first lateral and oppositely lateral walls 34 and 36. The preferred close fitting engagement of the third aperture 16 to the outside diameter of the antenna base 48 further stabilizes the shroud 1 by preventing rotation of the shroud about screw 22.

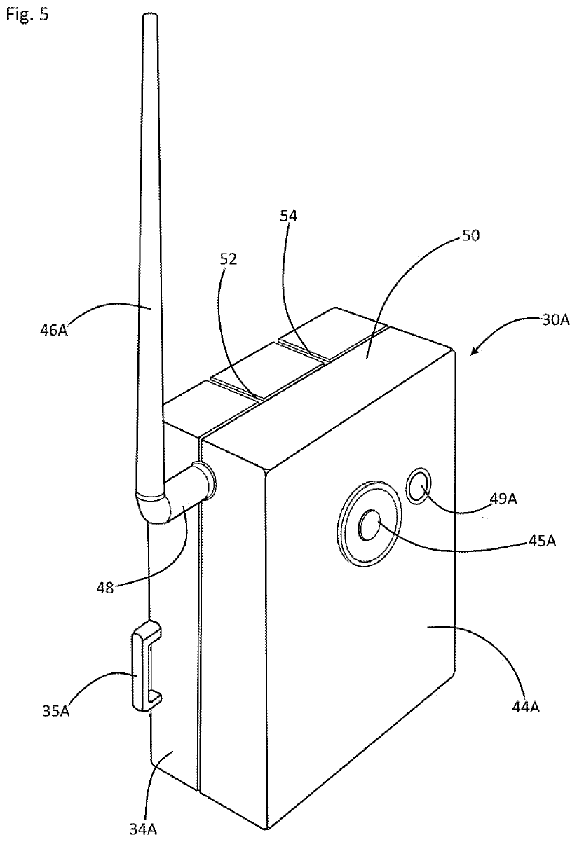

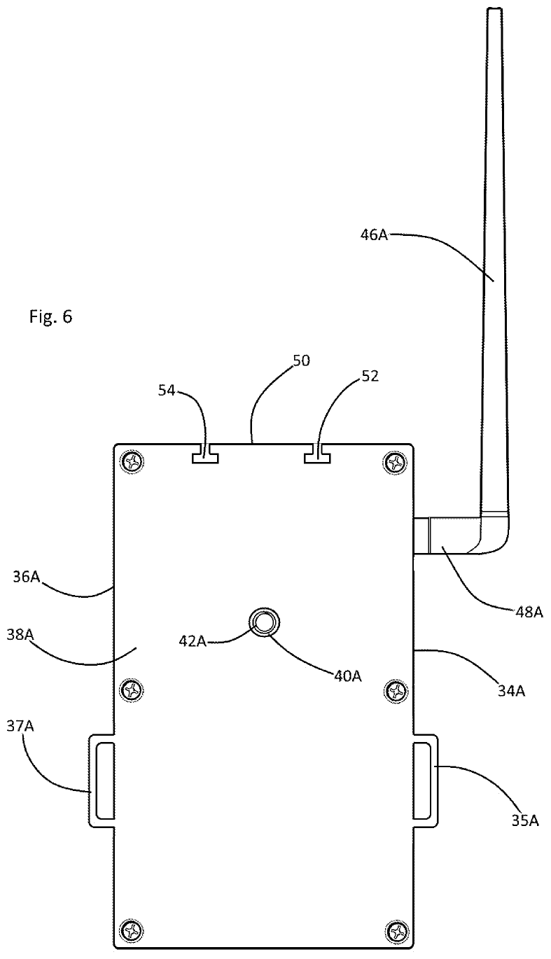

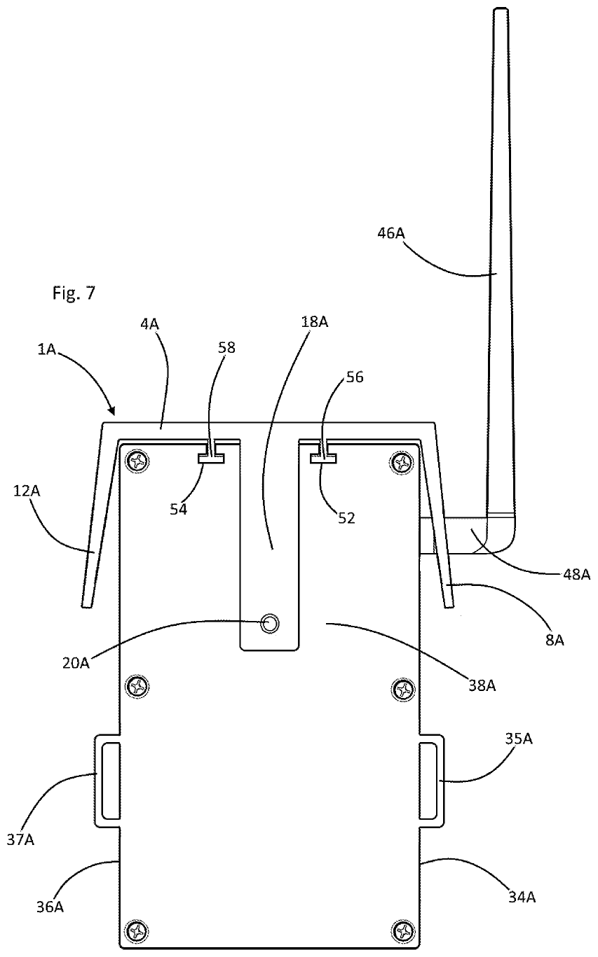

Referring to FIGS. 5-7, an alternate embodiment of the instant inventive assembly is presented. Structure identified by numerals appearing in FIGS. 5-7 having a suffix “A” are configured substantially identically with similarly numbered structures appearing in FIGS. 1-4. The trail camera 30A of FIGS. 5-7 additionally presents an upper longitudinally extending “T” channel which opens upwardly and rearwardly. In mechanical coordination with such “T” channel 52, the alternatively combined shroud assembly 1A presents a longitudinally extending “T” ridge 58 which is fitted for sliding receipt by and secure mounting engagement within the “T” channel 56. The interconnected combination of the “T” channel 52 and the “T” ridge 56 constitutes a first “T” ridge and “T” channel fastener assembly component. In the preferred embodiment a second “T” ridge and “T” channel fastener 58,54 is provided. Such first and second “T” ridge and “T” channel fastener combination components preferably extended parallel to each other and are laterally displaced from each other. Where, as indicated in FIG. 7, the shroud 1A is supported by the depicted lateral and oppositely lateral “T” ridge and “T” channel fasteners 56,52 and 58,54, the shroud's second aperture 20A may less precisely align with the case's first aperture 40A. Such laterally paired “T” ridge and “T” channel fasteners provide sufficient mounting support for the assembly, obviating the need for a mounting screw within first and second aperture 40A and 20A

Referring to FIG. 1 it may be seen that the forward ends 6, 10, and 14 of the second upper wall 2, the second lateral wall 8, and the second oppositely lateral wall 12 extend forwardly beyond the forward face 44 of the camera 30. Such excess forward wall extensions advantageously form a protective eve which provides weather shielding for the camera lens 45 and the motion detector 49.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. An assembly for shrouding a trail camera, said camera comprising a case comprising a first lateral wall having a forward end, a first oppositely lateral wall having a forward end, a first upper wall having a forward end, and a first rear wall, said camera further comprising an antenna mounted upon the case's lateral wall, said camera further comprising a first aperture opening rearwardly at the first rear wall, said assembly comprising:
(a) A second upper wall having a lateral end, an oppositely lateral end, and a rear end;
(b) A second lateral wall fixedly attached to and extending downwardly from the second upper wall's lateral end;
(c) A second oppositely lateral wall fixedly attached to and extending downwardly from the second upper wall's oppositely lateral end;
(d) A second rear wall fixedly attached to and extending downwardly from the second upper wall's rear end; and
(e) Second and third apertures respectively opening at the second rear wall and the second lateral wall, the second aperture being positioned for, upon the third aperture's receipt of the antenna, rearwardly overlying the first aperture.

2. The assembly of claim 1 comprising a screw adapted for, upon the positioning of the second aperture over the first aperture, extension through the second aperture into engagement with the first aperture.

3. The assembly of claim 2 wherein the second rear wall is configured as a leg.

4. The assembly of claim 3 wherein, upon the receipt by the third aperture of the antenna, the forward ends of the second lateral wall, the second oppositely lateral wall, and the second upper wall respectively extend forwardly from the forward ends of the first lateral wall, the first oppositely lateral wall, and the first upper wall.

5. The assembly of claim 4 wherein the third aperture is closely fitted to the antenna.

6. The assembly of claim 1 further comprising a first “T” ridge and “T” channel fastener, said fastener comprising a ridge extending downwardly from the second upper wall.

7. The assembly of claim 6 wherein, the first “T” ridge and “T” channel fastener's “T” ridge is adapted for forward sliding receipt within said fastener's “T” channel.

8. The assembly of claim 7 further comprising a second “T” ridge and “T” channel fastener, said second fastener's “T” ridge extending downwardly from the second upper wall.

9. The assembly of claim 8, wherein the first and second “T” ridge and “T” channel fasteners extend substantially parallel to each other.

10. The assembly of claim 5 wherein the second lateral wall and the second oppositely lateral wall respectively splay laterally and oppositely latterly.

11. The assembly of claim 10 wherein the second lateral wall and the second oppositely lateral wall respectively splay laterally and oppositely laterally.
